(19) United States
(12) Patent Application Publication
(10) Pub. No.: US 2008/0228391 A1
(43) Pub. Date: Sep. 18, 2008

(54) Navigation Interface System

(76) Inventor: Shahriar Sarkeshik, Northridge, CA (US)

Correspondence Address: THE ECLIPSE GROUP, 10605 BALBOA BLVD., SUITE 300, GRANADA HILLS, CA, 91344, US

(21) Appl. No.: 11/572,209

(22) PCT Filed: Jul. 18, 2005
(86) PCT No.: PCT/US05/25434

§ 371 Date: Aug. 7, 2007

Related U.S. Application Data
(60) Provisional application No. 60/588,585, filed on Jul. 17, 2004.
(60) Provisional application No. 60/622,511, filed on Oct. 26, 2004.
(60) Provisional application No. 60/699,044, filed on Jul. 13, 2005.
(60) Provisional application No. 60/699,789, filed on Jul. 15, 2005.

(51) Int. Cl. G01C 21/30

(52) U.S. Cl. 701/208

(57) ABSTRACT

The invention provides for a system capable of interfacing with a navigation system to provide the navigation system with the capability of generation routing information from the input of data that is not recognizable by the navigation system. The system receives data unrecognizable by the navigation system, which may be associated with at least one geographic identifier. The system is further capable of using the unrecognizable data to obtain additional data associated with the at least one geographic identifier associated with the unrecognizable data. The system then provides the additional data to the navigation system in a format recognizable by the navigation system.

### CROSS-REFERENCE TO RELATED APPLICATIONS

This application claim priority to PCT Patent Application No. US2005/______, filed on Jul. 16, 2005, titled Location Codes for Destination Routing; U.S. Provisional Application Ser. No. ______, filed on Jul. 15, 2005 titled Navigation Interface System; U.S. Provisional Application Ser. No. ______, filed on Jul. 13, 2005, titled Location Codes for Destination Routing; U.S. Provisional Application Ser. No. 60/622,511, filed on Oct. 26, 2004, titled Location Codes for Destination Routing; U.S. Provisional Application Ser. No. 60/588,585, filed on Jul. 17, 2004, titled Method and System For Using Location Codes For Destination Routing. All of the above cited references are incorporated, by reference, in their entirety into this application.

### FIELD OF THE INVENTION

The present invention relates to a system capable of recognizing data that is unrecognizable by a navigation system and providing the navigation system with recognizable data. In particular, the system enables a navigation system to generate routing information based upon the entry of data representative of a geographic identifier that is not in a format recognizable by the navigation system as a geographic identifier.

### BACKGROUND

Using navigation systems to calculate routing information is becoming increasingly popular. Currently, navigation systems may be found on the Internet, in vehicles, in cell phones, in personal digital assistants, and other devices. Most navigation systems calculate routing information based in part upon the origination and/or destination location provided by the user. Typically, the system requires the user to input address information in the form of a street address. At a minimum, the system requires the user to input the house number and the street name. In some application, the user is also required to enter the city and state of the address. Because most street addresses are represented by both a series of numbers and a series of characters identifying a particular street, in some navigation systems, such as those used in vehicles, the entry of the street address is performed in two steps. One step provides for the entry of the series of numbers and the other provides for the entry of a series of characters representative of the street name. Further, the process of entering the street name into the system often includes identifying which street name, from a list of similar street names, the user's input was intended to represent. This is often required when the only distinction between a group of street names is the inclusion of a directional indicator or the inclusion of descriptive terms to describe the street type, such as terrace, boulevard, street, lane, circle, court and etc. Accordingly, the process of entering origination and/or destination information into a navigation system can be rather cumbersome. Some navigation systems provide alternative mechanisms for selecting destination locations. These alternative mechanisms are typically just as involved, if not more involved, than the process of entering an address into a navigation system. Such alternative mechanisms are typically designed to assist a user with generation routing information when the user does not know the exact address of a particular location. For example, many navigation systems allow a user to look up popular destination locations, i.e., points of interest, by category or other identifying information. Locating a destination in this manner often requires sifting through a lot of information before finding the desired location.

FIG. 1 depicts a block diagram that illustrates the general modules of a typical navigation system. As illustrated, the navigation system 100 is controlled by a main/routing program 102. The navigation system 100 further includes an input interface 104 that allows the user to input via external input device(s) 106. Optionally, some navigation systems 100 are equipped with a speech recognition interface 108 that allows the user to interact with the system via voice. The system may include a Global Positioning System 110 to provide the current coordinates to the main/routing program 102 for use as the starting position. For purposes of this application, any device that utilizes or can interface with a mechanism for receiving transmitted information to identify or calculate its current location shall be considered as having a Global Positioning System (“GPS”). Usually, the GPS 110 is a standard component in navigation systems 100 for automobiles and may also be present in cell phones or other handheld devices, but is typically not found in mapping software programs that determine driving direction based on the user input of originating and destination locations, such as MapQuest®, which is accessible via the Internet. Thus, when a GPS 110 is present, for example in an automotive navigation system, inputting the starting address is not required. For mapping software programs, where no GPS 110 is included in the system, the user must input the starting address 106, which may be stored in memory for subsequent use, to provide the desired routing information.

Most commonly, starting addresses and designation addresses, when provided by the user, are provided through a memory look-up, or through physical input of the starting addresses and destination addresses. The starting addresses and destination addresses are input into the navigation system in the form of a street address, typically representative of a number followed by the street name. The city and state where the street address is to be located is also typically required to be entered by the user to restrict the field of search and to distinguish between similar street addresses located in different cities and/or states.

The main/routing program then uses the input information, including the starting address, obtained through the GPS or through user input, and the destination address to obtain routing information from the starting address to the designation address. Using the obtained address information, the main/routing program 102 interfaces with the map/database interface 112 with a database 114 to obtain the desired routing information. This database 114 may be maintained local to the navigation system or may be obtained through an interface/network 116.

Once the routing information is obtain, the main routing program 102 can output the routing information through a graphics interface 118 on a display 120, such as an on-screen display of a map and/or turn-by-turn graphic or textual instructions. The output could also be in the form of turn-by-turn vocal instructions provided through speech synthesizer interface 122. Map and other navigation instructions may also be provided to the user on paper via the printer interface 124. Routing information can be conveyed in a number of ways.

While current navigation systems do provide users with the ability to store select destination information for quick recall, the number of destination that can be stored for quick recall is limited. Thus, this easy recall feature only alleviates the burden associated with entering addresses information for a small number of previously identified locations. Some navigation system will also display the location of certain types of entities, such as gas stations, ATMs, etc. In some navigation systems, routing information may be generated to any of these displayed entities by selecting the icon representing the entity on the screen. As demonstrated by these examples, with few exceptions, a user is required to provide the navigation system with address information to obtain routing information to that destination.

With the increase in the use of navigation systems in cars, the process of entering destination locations into navigation systems has become problematic. Until recently, the difficulties and/or obstacles associated with using address information to designate origination and/or destination locations have been tolerated. In recent years, research has been published that identifies one cause of car accidents to be inattentive drivers that have become distracted by entering address information into their car navigation system. As a result, many car navigation systems now disable the system feature that allows for the input of address information into the navigation system when the car is in motion. Thus, a user is only able to calculate routing information using a street address when the car is stopped. By disabling this feature of a navigation system, the ability to use the navigation system to provide routing information is limited.

While the difficulties associated with entering address information into a navigation system are highlighted by car navigation systems, these difficulties are universal to all navigation systems. In the case of cell phones, the entry of address information is further complicated by the association of several characters to the same key on the keypad. Not only does the use of a keypad to enter address information require a user to switch between using the key pad to enter numbers and using the key pad to enter letters, it also may require multiple key strokes to enter certain letters.

For this reason, a new method has been developed that eliminates the need to identify destination and/or origination locations by street address. This new method is described in co-pending PCT Patent Application No. US2005/______. In summary, this new method associates geographic locations with a series of characters that can be entered into a navigation system much easier than entering a street address. The series of characters can be comprised of letters, numbers, symbols or any combination thereof. By way of example, the series of characters may be comprised entirely of numbers. By using a series of characters as input data representative of a designation location, the burden of entering designation information into the system in two steps is eliminated because the entire series may be entered in one input field. Further, the system would no longer require the use of look-up tables to identify which, of a number of street names identified as possibly matches, is the desired street name. For purposes of this application, any series of characters generated in accordance with the above described method, which is further described in PCT Patent Application No. US2005/______, which is incorporated into this application by reference in its entirety, shall be referred to as location code.

Any data that is not recognized by conventional navigation systems as having an association with a geographic location, including but not limited to a location code, shall be referred to in this application as “unrecognizable or unrecognized data”. Data “not recognized by the navigation system” as having an association with a geographic location may include (i) data that the navigation system is unable to accept as input data (ii) data that the navigation system cannot associate with at least one particular geographic location; or (iii) data that the navigation system is unable to manage, process or to use for the purposes of generating routing information. For purposes of this application, “data” shall mean information, segments of information or the raw material of information. Data may further include useful, irrelevant and/or redundant information or raw material. Data may take various forms, including, but not limited to, numbers, letters, symbols, text, graphics, images, audio and/or video and may comprise a single fact or a collection of facts, raw facts, statistical data, metadata, binary digits, measurements, concepts, instructions, animation, databases, links, programs, computer files, records, and etc. Data commonly used in connection with a navigation system may take the form of a location code, geographic identifying information (e.g., coordinate information, all or part of a zip code, post code, a telephone number, a parcel number, or other similar data that can be used to directly or indirectly identify at least one associated geographic location), metadata, event data, commands, database information, computer files, computer programs, such as scheduling and/or contact management programs, and security or rights management information, among other things. Any of the above data formats, among others, may be considered unrecognized data if the data is not recognized by the navigation system.

One inherent problem associated with using location codes as an alternative geographic identifier to street addresses is that navigation systems may not be capable of recognizing location codes as data representative of a geographic identifier. Thus, the location codes can be unrecognized data to a navigation system. A need therefore exists for a system that is capable of recognizing location codes as data representative of geographic identifiers and that can interface with navigation systems to provide the navigation systems with recognizable data representative of geographic locations associated with location codes. In other words, a need exists for a system that will enable navigation systems to be able to generate routing information based upon the entry of unrecognizable data.

Further, location codes and/or their associated geographic identifiers may also be associated with other types of data, such as metadata. As used in this application, “metadata” is any data about data. For example, metadata may include, but not be limited to, information in the form of binary, text, characters, graphics, images, pictures, audio, video, animation, files, files created by different programs, organized or unorganized data, information, databases, links, programs, attributes or any other format for communicating information.

There are many different ways that data may be associated with a unrecognized data and provided to a user. One example of such association techniques is using information or web technology. This includes but not limited to using HTML, XML, PDF, application programs, various multimedia players, databases, programming languages such as Flash, Java, Java script, C, C++, C# and/or proprietary association techniques etc. Accordingly, a further need exists for a system capable of recognizing unrecognized data, obtaining associated data, including metadata and/or geographic identifying information and interfacing with a navigation systems to provide the navigation systems with the associated data in a format recognizable by the navigation system. Additionally, it may be desirable or necessary to process the associated data prior to providing the data to the navigation system. Therefore, a further need exists for a system that is capable of processing associated data and providing the processed data to the navigation system in a format recognizable by the navigation system and/or the user.

### SUMMARY

The invention provides for a system capable of interfacing with a navigation system to provide the navigation system with the capability of generation routing information from the input of data that is not recognizable by the navigation system. The system receives data unrecognizable by the navigation system that is associated with at least one geographic identifier. The system is further capable of using the unrecognizable data to obtain additional data associated with the at least one geographic identifier associated with the unrecognizable data. The system then provides the additional data to the navigation system in a format recognizable by the navigation system.

Other systems, methods, features and advantages of the invention will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 shows a block diagram of the components and operation of one example prior art navigation system.

FIG. 2 shows a block diagram illustrating the components and operation of one example of one implementation of a navigation interface system of the invention used in conjunction with a navigation system.

FIG. 3 depicts a block diagram that illustrates the general components of one example of one implementation of how a conventional navigation system may be enhanced to utilize location codes by adding a navigation interface system to the navigation system platform.

FIG. 4 depicts a block diagram that illustrates the general components of one example of one implementation of how a conventional navigation system may be enhanced to utilize location codes by interfacing it to a navigation interface system that resides on separate platform than the navigation system.

FIG. 5 is a flow diagram that illustrates one example of how a navigation interface system provides recognizable data to a navigation system from the input of unrecognizable data.

FIG. 6 show one example of one implementation of flow diagram that illustrates a client side process of a navigation interface system when the navigation interface system includes both client and server components.

FIG. 7 show one example of one implementation of flow diagram that illustrates the server side process of the client/server navigation interface system illustrated in FIG. 6.

FIG. 8 shows one example of an illustration of a cellular telephone using both the navigation interface system and the navigation system, as illustrated in FIG. 3.

FIG. 9a show one example of an illustration of a screen display for the entry of unrecognizable data.

FIG. 9b shows one example of an illustration of a cellular telephone as it might appear displaying associated data to the user.

FIG. 9c shows one example of an illustration of a cellular telephone as it might appear displaying the user selecting the second location on the displayed list of locations shown in FIG. 9b.

FIG. 9d illustrates one example of an illustration of a cellular telephone providing routing information to the user in the form of turn-by-turn instructions.

FIG. 10 shows one example of one implementation of a PDA including a navigation system program.

FIG. 11 shows one example of one implementation of the PDA illustrated in FIG. 10 interfacing with a navigation interface system.

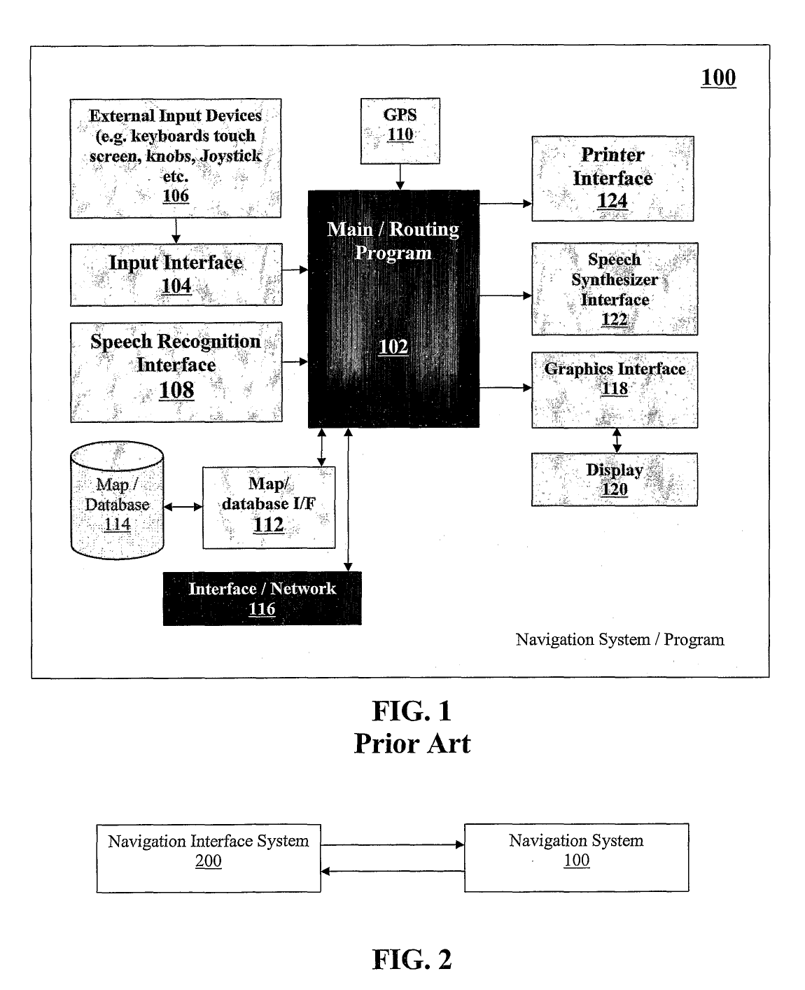

### DETAILED DESCRIPTION

As illustrated by FIG. 2, a navigation interface system 200 is provided that is capable of processing data that is unrecognizable by a navigation system 100, (i.e., “unrecognizable or unrecognized data”). For purpose of this application, a navigation system 100 shall mean any piece of hardware, software, or combination thereof that can, as at least one of its functions, provide mapping, routing, and/or location information, whether or not it includes GPS or has the ability via a wireless or wired network to access a GPS device.

The navigation interface system 200 is capable of receiving unrecognizable data and providing data representative of, or associated with, the unrecognizable data to the navigation system 100 in the form of recognizable data. “Recognizable or recognized data” shall mean any data that the navigation system 100 is able to receive and process.

The navigation interface system 200 can interface with the navigation system 100 by any known method for interfacing two systems and/or programs that will allow at least one of the systems or program to transmit information to the other. For example, the systems or programs may interface via any type of network or interface, serial interface, parallel interface, USB, wireless communication, the Internet, a local area network, a wide area network, a infra-red signal, shared memory, shared registers and/or etc. Although not necessary, the navigation system 100 and the navigation interface system 200 may also exchange information that could include command and/or status information. Information may be provided and/or exchanged by the navigation interface system to the navigation system over an interface, network, navigation system input interface and/or navigation system output interface, among other interface/networks.

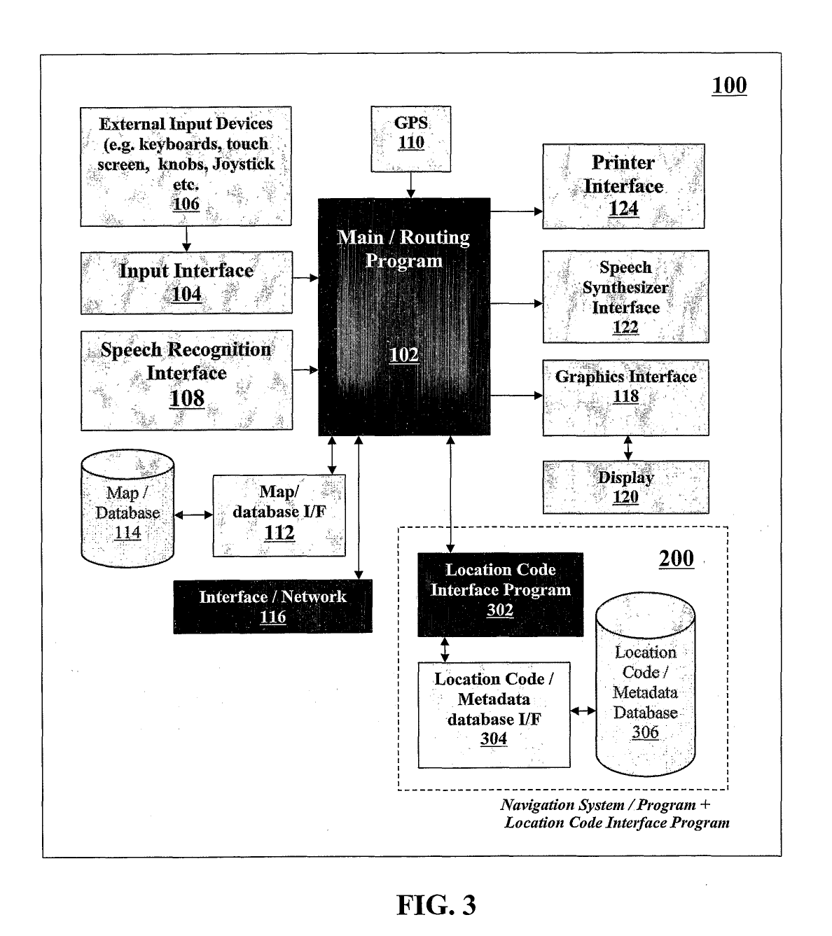

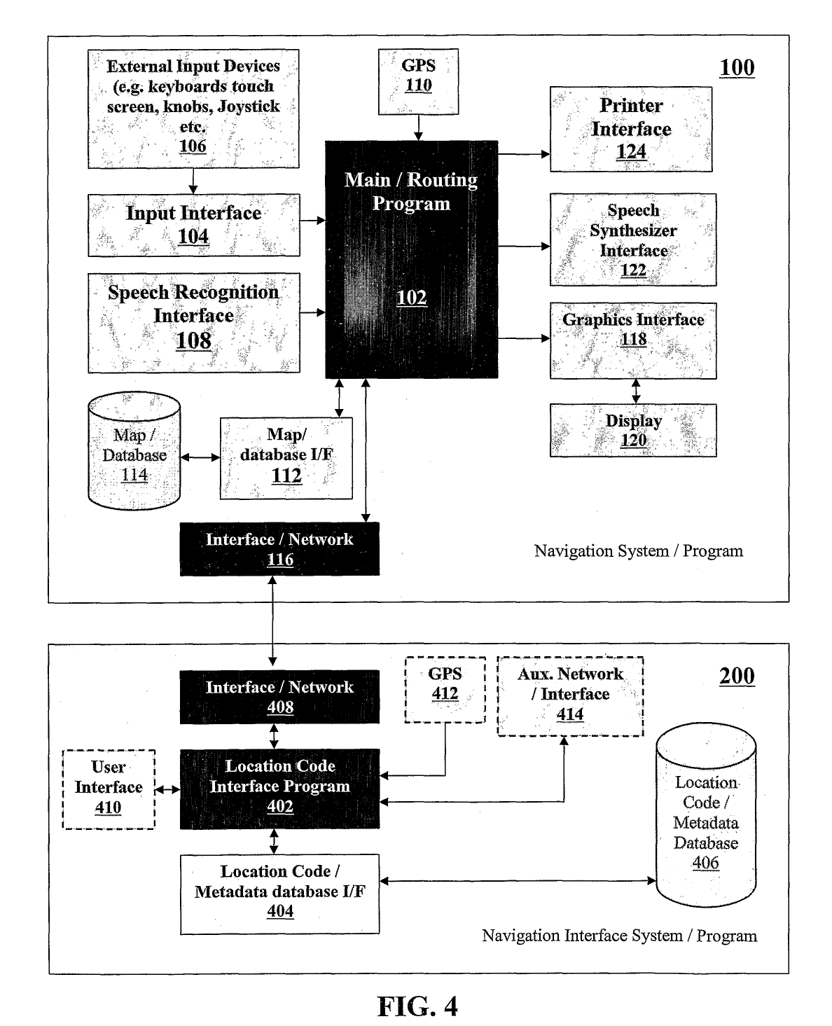

Although FIG. 2 depicts both the navigation interface system 200 and the navigation system 100 as two separate systems 200 and 100, respectively, those skilled in the art will recognize that both the navigation interface system 200 and the navigation system 100 can be comprised of either a single system or two separate systems each system of which may be comprised of a single system, or more than one system, module or component that collectively comprise each system. Examples of two such implementations are illustrated in FIGS. 3 and 4, as described below.

FIG. 3 depicts a block diagram that illustrates the general components of one example of one implementation of how a conventional navigation system 100 may be enhanced to utilize location codes by adding a navigation interface system 200 to the navigation system platform 100. In this example, the navigation interface system 200 includes a location code interface program 302. As illustrated by FIG. 3, the location code interface program 302 may run partially or completely on the same platform as the navigation system 100. The location code program 302 interfaces with main/routing program 102 of the navigation system 100. Through this interface, command and data may be exchanged between the two programs 102 and 302 and also may provide access to many of the on-board modules of the navigation system 100, such as the GPS 110, interface/network 116, input interface 104, graphics interface 118, speech recognition interface 108, speech synthesizer interface 122, printer interface 124 and/or other available modules. The main/routing program 102 and location code interface program 302 may have any type of relationship, including, but not limited to, master/slave, slave/master or peer-to-peer. In one example of one implementation of a master/slave configuration, the main/routing program 102 may call the location code interface program 302 when it comes across an unrecognizable data such as a location code. In this case the location code interface program 302 may only react to the main/routing program's 102 requests and the user may only interact to location code interface program 302 through main/routing program 102. In another example of one implementation of a slave/master configuration, the location code interface program 302 may provide the user with an interface to receive an unrecognizable data such as a location code, obtain and format the associated data and provide the result to the user and the main/routing program 102 along with an appropriate command such as a “route” command, In this configuration, the user may seamlessly interact with both the main/routing program 102 and location code interface program 302 and further, the location code interface program may at times control the main/routing program 102. The main/routing program 102 and location code interface program 302 relationship may change dynamically during the operation.

Additionally, the location code program 302 through location code/metadata database I/F 304 is able to access the location code/metadata database 306 and provide the appropriate data to the user and/or the main/routing program. For example, the data could be the street address associated with the location code that after presentation to the user can be formatted appropriately and communicated to the main/routing program 102. Many commercially available navigation programs have software development kits (SDK) that enable third party developers to interface with their programs. Such SDKs can be used for development of the navigation interface system 200. Of course, availability and use of SDKs are not a requirement for the development of a navigation interface system 200. As is true for any navigation interface system 200 described herein, in addition to receiving unrecognizable data and providing data representative of, or associated with, the unrecognizable data to the navigation system 100, the navigation interface system 200 may provide additional functionality beyond the capabilities of the main/routing program 102. Such functionalities may include any function or process that the navigation system 100 is not capable of performing without installing a new version of the main/routing program or upgrading the main/routing program. These functionalities may include any of the functionalities described in co-pending PCT Patent Application No. US2005/______ and may include any known or future developed function, which may include, but not be limited to, directly interacting with the user, processing data, processing data based on different criteria, input and/or function requirements, interfacing with other programs used by the navigation system or the device upon which the navigation system operates, including, but not limited to, contact management or scheduling programs.

Through the interface between the navigation system 100 and the navigation interface system 200, the navigation system 100 may also provide access to the external input devices 106, the display 120 and the map/database I/F 112 and the map database 114. Accordingly, the navigation interface system 200 may request input through the display 120, receive input through the external input devices 106 and process the received data using the map/database I/F 112 and the map database 114 of the navigation system 100.

While FIG. 3 illustrates the components of the navigation system 100 and the navigation interface system 200 separately, both systems can share like components rather than each utilize separate components. For example, both systems 200 and 100 can reside together in the same memory or in separate memory and can use a single processor or a multiple processors. Accordingly, the navigation interface system 200 may take the form of a software module, a hardware component or a combination thereof that may perform the functions or processes described herein. With respect to software, the navigation interface system 200 may be all or part of a program that may be composed of one or more systems or programs that are independently developed and linked together when the program is executed and may be contained, entirely or in part, in the navigation system 100. Thus, the navigation interface system 200 may take the form of an upgrade to the main/routing program 102 of the navigation system 100 or be included as part of a new version of the main/routing program 102 of the navigation system 100. With respect to hardware, the navigation interface system 200 may be any self-contained hardware component or a hardware component that comprises two or more hardware or software components. A navigation system and a navigation interface system may run on the same hardware platform.

FIG. 4 depicts a block diagram that illustrates the general components of one example of one implementation of how a conventional navigation system 100 may be enhanced to utilize location codes by interfacing it to a navigation interface system 200. In this example, the location code interface program 402 of the navigation interface system 200 may run partially or completely on a separate platform than the one used for the navigation system 100 and interfaces to the navigation system 100 via an interface/network 408. The location code interface program 402, through location code/metadata database I/F 404, may access the location code/metadata database 406. The location code interface program 402 through the interface/network 408 connection may, in addition to exchanging data and commands, be able to access different modules of the navigation system 100, including GPS 110, interface/network 116, input interface 104, graphics interface 118, speech recognition interface 108, speech synthesizer interface 122, printer interface 124 and other available modules. Alternatively, or in conjunction with the above capability, the navigation interface system 200 may include a separate user interface 410, GPS 412 and/or auxiliary networking/interface 414 among other modules. The auxiliary network/interface 414 may be any type of network or interface. The navigation system 100 and navigation interface system 200 may have any type of relationship including but not limited to master/slave, slave/master and/or peer-to-peer. The location code interface program 402, through location code/metadata database I/F 404, may access the location code/metadata database 406 and provide the appropriate data to the user and/or the main/routing program 102 of the navigation system 100. For example the data could be the street address associated with the location code that after presentation to the user can be formatted appropriately and communicated to the main/routing program 102 through interface/network 116.

Similar to the navigation interface system 200 illustrated in FIG. 3, through the interface/network 408 and 116 between the navigation interface system 200 and the navigation system 100, respectively, the navigation system 100 may also provide the navigation interface system 200 with access to the external input devices 106, the display 120 and the map/database I/F 112 and the map database 114. Accordingly, the navigation interface system 200 may request input through the display 120, receive input through the external input devices 106 and process the received data using the map/database I/F 112 and the map database 114 of the navigation system 100. In this manner, the interface system and the navigation system may operate together in a seamless manner to the user. Although not shown, in this example, a part of navigation interface program may run on the navigation system platform.

Although the navigation interface system 200 may have a dedicated processor, the navigation interface system 200 may be configured to utilize all or part of the processing capabilities of the navigation system 100. Although the navigation interface system 200 is designed primarily for the purpose of providing additional functionality to the navigation systems 100, nothing prevents the configuration of the navigation system 100 from being modified to utilize components of the navigation interface system 200.

Although FIGS. 3 and 4 illustrate two examples of one implementation of a navigation system with their capabilities enhanced through integration of a navigation interface system. In light of the various implementations offered above, those skilled in the art will recognize that the navigation system 100 and the navigation interface system 200 may include all of the illustrated components, or may be designed to exclude certain of the illustrated components, include additional components, may combines two or more illustrated components into one component and/or may replace a component with a different type of component. Many alternative implementations of navigation interface system, whether implemented in hardware, software or any combination thereof, including, but not limited to standalone or client/server designs are possible and are within the scope of this invention. Accordingly, the invention is not to be restricted by the described implementations. Further, although FIG. 3 and FIG. 4 examples concentrate on location code processing, they can be easily expanded to process any unrecognizable data. All such implementations are within scope of this invention and are intended to be protected by the accompanying claims.

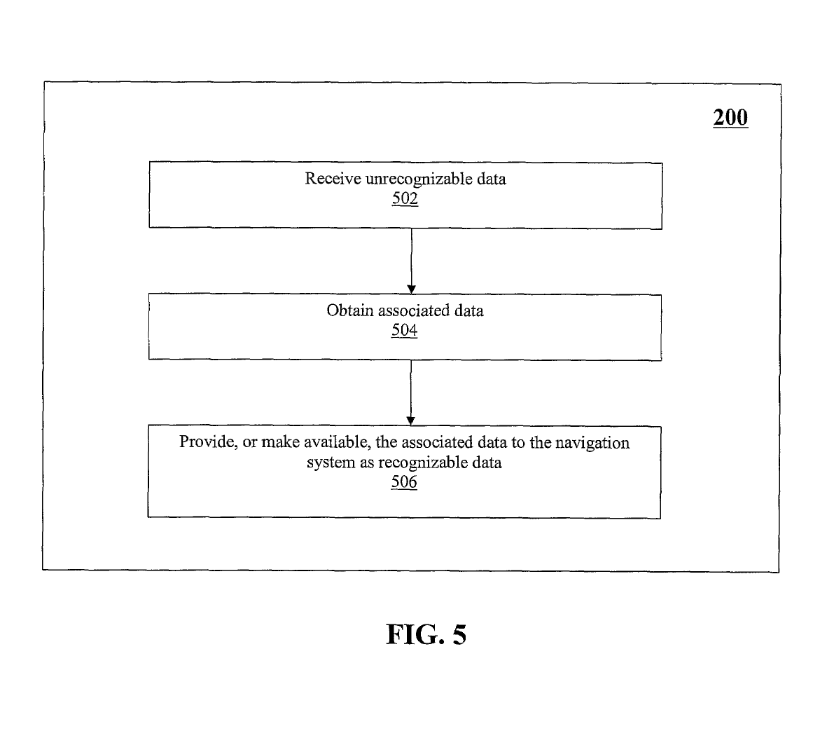

FIG. 5 is a flow diagram that illustrates one example of one implementation of how a navigation interface system 200 may provide recognizable data to a navigation system 100 from the input of unrecognizable data. As set forth in FIG. 5, the navigation interface system 200 first receives the unrecognizable data 502. Once received, the navigation interface system 200 obtains additional data that is associated with the unrecognizable data 504. Thereafter, the navigation interface system 200 provides the additional data to the navigation system in a format that is recognizable by the navigation system 506.

As illustrated by step 502, unrecognizable data is received by the navigation interface system 200. In step 504, the navigation interface system 200 uses the received unrecognizable data to obtain associated data 504. The associated data is data that has some relationship with the unrecognizable data. The associated data may include either or both recognizable data or unrecognizable data. If the associated data includes unrecognizable data, the system 200 will need to further process or reformat the unrecognizable data before it can take the form of recognizable data.

Such associated data may include data derived through (i) cross-referencing the unrecognized data with data contained in single or multiple database, (ii) reformatting the unrecognized data, (iii) extrapolating the unrecognizable data, (iv) translating the unrecognized data, (v) applying an algorithm to the unrecognized data or (vi) any other method of processing data. The process of obtaining associated data through the use of the received unrecognized data may be performed locally, may utilize interface or network communication to obtain the associated data or may obtain the associated data using both local resources and resources available through interface or network communications.

Such associated data may include any type of data associated with one or more geographic locations represented by the unrecognizable data. Associated data may include, but not be limited to, geographic identifying information, such as geographic coordinates and/or street addresses, metadata, and/or other similar information.

As illustrated in step 506, once the associated data is obtained, the associated data may be formatted, if necessary, into recognizable data. Once formatted into recognized data, the navigation interface system 200 may transmit the information to the navigation system for processing or may simply make the data available for retrieval by the navigation system, as requested or required. For purpose of this application, providing the formatted data to the navigation system shall mean transmitting the data to the navigation system, making the formatted data available for retrieval by the navigation system or making the formatted data available to at least one intermediary process that links the navigation system and the navigation interface system. Further, formatting the associated data as recognizable data may not be necessary if the associated data was obtained in the form of recognizable data. However, formatting the associated data may include either or both processing the associated data and reformatting the associated data. The processing of the associated data may be required to convert the associated data into recognizable data or in response to a specific user request or navigation system function. Further, providing or making the recognizable data available to the navigation system may require providing the recognizable information in segments. In summary, formatting the associated data may include any process necessary to allow the navigation system to use the obtained associated data to perform a requested function.

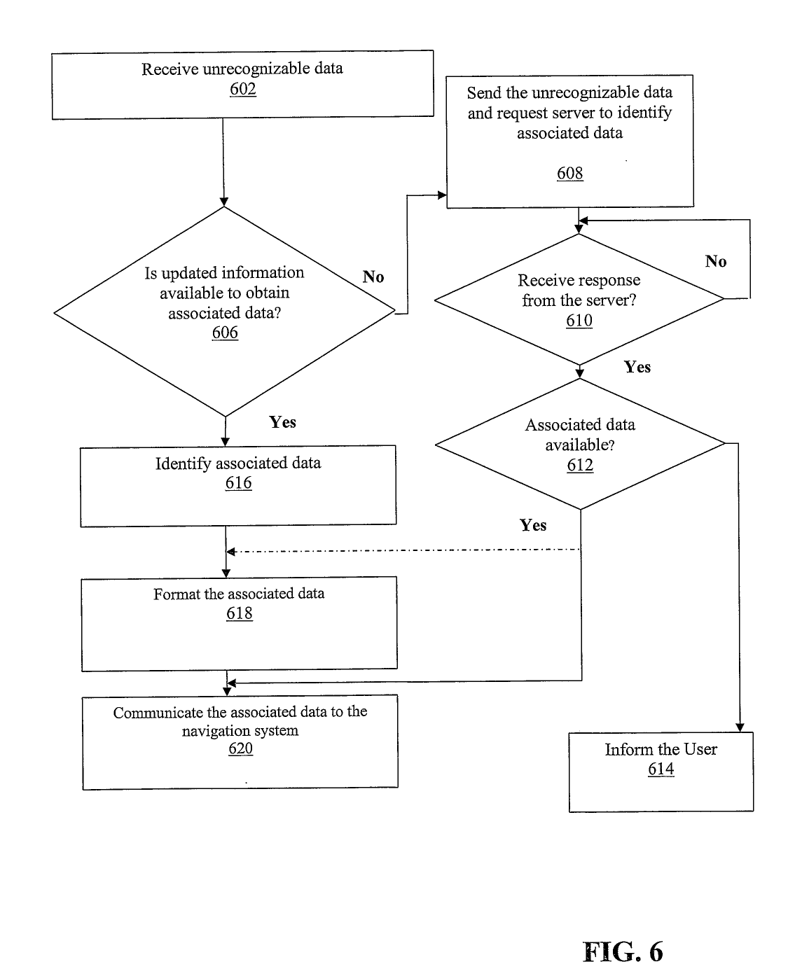

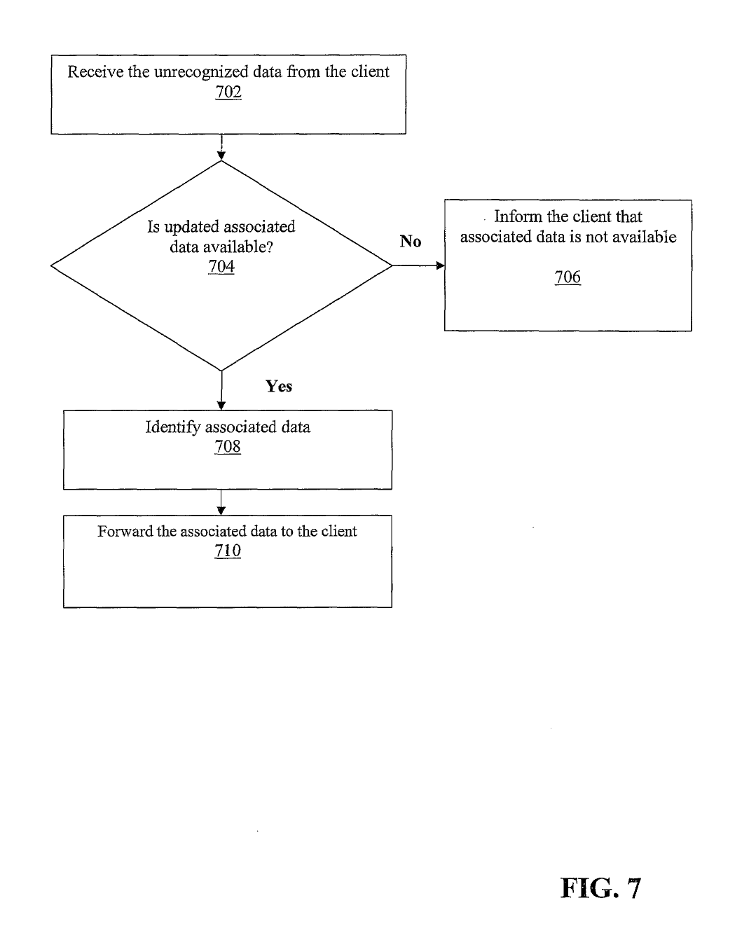

Any of the processes and functions of the navigation interface system 200 may be performed locally, may utilize interface or network communication to process or obtain data or may use both local and/or interface/network accessible resources. Examples of one such implementation is illustrated in FIGS. 6 and 7, described below, which together show one example of one implementation of a navigation interface system that may include both a client and a server components to provide recognizable data to a navigation system.

FIG. 6 show one example of one implementation of flow diagram that illustrates a client side process of a navigation interface system when the navigation interface system includes both client and server components. In this example, the navigation interface system receives unrecognizable data 602. To locate associated data, such as a geographic identifier associated with the unrecognizable data, the system may first determine if it can obtain the associated data using local resources, such as a cross-reference database 606.

If the client side of the navigation interface system cannot obtain the data using local resources, the client sends the unrecognizable data to the server with a request for associated data 608. The server then monitors for a response from the server 610. Once the response is received, the client determines whether the server was able to obtain associated data. If the server does not return associated data, the client may inform the user that no information is available by either informing the user that the unrecognizable data is invalid or that no information is available for the received unrecognizable data 614. If associated data is available, the client formats the associated data as recognizable data 618 and communicates the recognizable data 620 to the navigation system.

If, in step 606, the client determines that associated data may be obtain locally without requesting information from the server, the client identifies the associated data 616, if necessary, formats the associated data as recognizable data 618 and communicates the associated data to the navigation system. Although FIG. 6 shows the client formatting the associate data. The server may also format the associate data prior to sending the information back to the client. As such, if processing of the associated data is required in order to format the associated data, the processing can be performed by either the client or the server, although this is not shown in FIG. 6.

FIG. 7 show one example of one implementation of flow diagram that illustrates the server side process of the client/server navigation interface system illustrated in FIG. 6.

FIG. 7 is one example of one implementation of flow diagram of a server component of a navigation interface system. In this example, the server receives the unrecognized data from the client with a request for providing the associated data 702. The server then checks to see if associated data is available or can be obtained for the unrecognizable data 704. If associated data is not available, the server informs the client that no associated data can be obtained 706. If associated data can be obtained or identified, the server obtains the associated data 708. Once obtained, the server then provides the associated data to the client 710. Although not shown, the server may also format the data to recognizable data before providing it to the client.

Although FIGS. 6 and 7 illustrate one examples of one implementation of flow diagrams depicting a navigation interface system operation with both a client and a server component, in light of the implementations offered above, those skilled in the art will recognize that many other implementations are possible. These implementations include but not limited to standalone configuration, multiple client configuration and other client/server configurations. All such implementations are within scope of this invention and are intended to be protected by the accompanying claims.

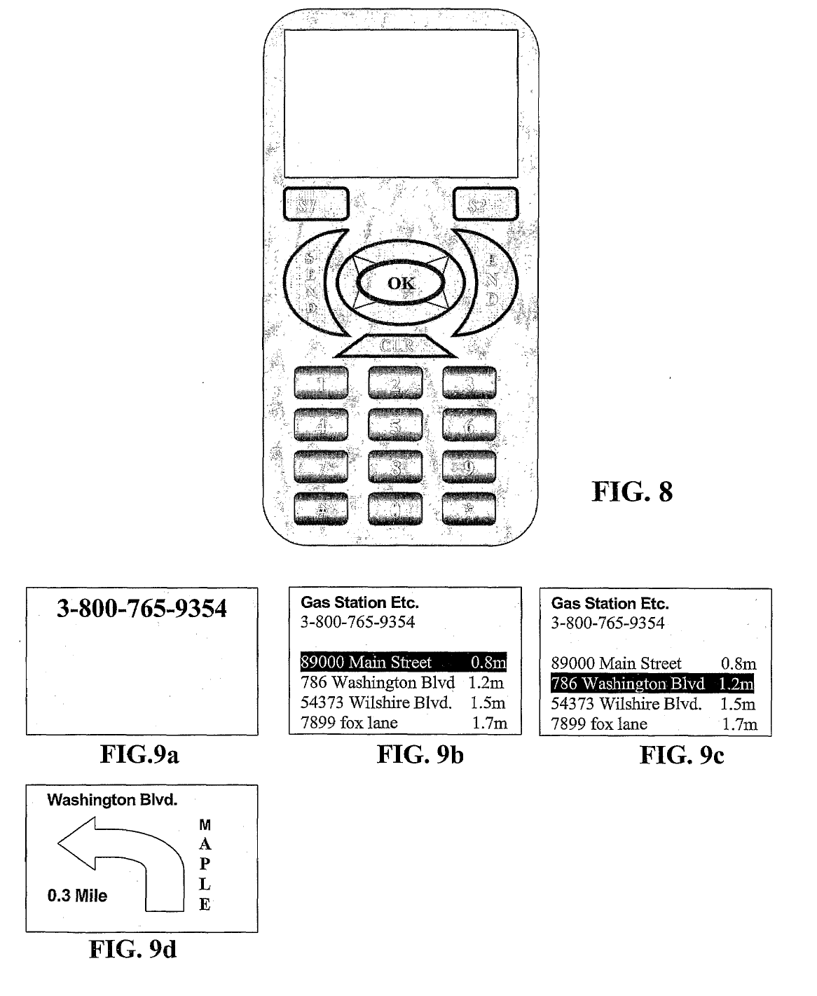

FIGS. 8 & 9 illustrate one example of one implementation of the navigation interface system as it may appear during operation in conjunction with a cellular telephone. In this example, the navigation interface system has either been integrated with the cell phone navigation system platform (similar to configuration illustrated by FIG. 3) or has been installed on the cell phone as a navigation system software and/or hardware upgrade or enhancement. When the navigation interface system is integrated into the existing navigation system platform on the cell phone, the relationship between the two systems may alternate from slave/master, master/slave or peer-to-peer during operation. The navigation interface system may access resources of the cell phone including the user interface and communication capabilities. Accordingly, the navigation interface system may operate seamlessly with the cell phone navigation system.

FIG. 8 shows one example of an illustration of a cellular telephone using both the navigation interface system and the navigation system, similar to the configuration illustrated in FIG. 3. As illustrated, the cellular telephone has a keypad for inputting information and a display for providing the results to the user. FIGS. 9a-9d shows one example of one illustration of how the navigation interface system may work in conjunction with the navigation system to provide the user with routing information based upon the entry of unrecognizable data into the user's cell phone.

FIG. 9a show one example of an illustration of a screen display for the entry of unrecognizable data. In this example, the unrecognizable data is a location code that is associated with several geographic locations. As show, the cell phone displays a screen for the input of the unrecognizable data, which is generated by the navigation interface system. Once the unrecognizable data is entered, the user may press the “SEND” button on the cell phone to request associated data. Since unrecognizable data may be in a number of different formats, the navigation interface system may require the user to request the type of unrecognizable data that the user desire to input prior to entry into the system. This will allow the navigation interface system to accept different formats of unrecognizable data and instruct the navigation interface system as to how it may obtain the associated data since different resources may be available to the navigation interface system for obtaining associated data depending upon the type of unrecognizable data received by the navigation interface system. Alternatively, the system may automatically recognize the different formats of unrecognizable data and handle them accordingly.

Examples of types of resources that may be available to the navigation interface system to obtain associated data may include, but is not limited to, techniques using information or web technology. Such techniques using information or web technology may include, but is not limited to, using HTML, XML, PDF, application programs, various multimedia players, databases, programming languages such as Flash, Java, Java script, C, C++, C#, proprietary association techniques, algorithms or other techniques for obtaining associated data from the unrecognized data.

FIG. 9b shows one example of an illustration of a cellular telephone as it might appear displaying associated data to the user. In this example, the associated data may be obtained locally, or due to memory and processing constraints, the navigation system may pass the unrecognized data to the server along with the GPS coordinates of the cell phone, which may be obtain through the navigation system. The server then obtains associated data related to the unrecognizable data. In this example, the unrecognizable data is associated with more than one geographic location. The unrecognizable data in this example is a location code that identifies the geographic location of gas stations operated by a specific company. The associated data may include the street address for each gas station within a specific area and any other data needed to identify the location of each gas station. Although not shown, the associated data may also include metadata or processed metadata related to each gas station, such as hours of operation and gas prices.

As illustrated by FIG. 9b, the cellular telephone display provides the user with a list of all associated gas stations within a certain distance from the current position, including the require travel distance. Further, the information is displayed with the nearest gas station first. The formatting of the associated data and the processing of the associated to sort the listing of the gas stations may be performed by the client and/or server side of the navigation interface system, or the navigation system. In the case of the server, the server may process and format the associated data and send the recognizable data to either the client side of the navigation interface system or the navigation system for display. Alternatively, the server may pass the associated data back to the client side of the navigation interface system to be formatted as recognized data and passed to the navigation system for processing or the navigation interface system may process, format and display the recognizable data.

As illustrated in FIG. 9b, the cellular telephone may then display the name of the company with a list of closest locations. The navigation interface system or the navigation system then provides the user with the ability to select one of the listed locations by using, for example, the mouse (up/down).

FIG. 9c shows one example of an illustration of a cellular telephone as it might appear displaying the user selecting the second location on the displayed list of locations shown in FIG. 9b. Once selected, the user may then press the “SEND” or “ENTER” key, which may send a route command to the navigation interface system or navigation system. At this point, the selected information may be captured by the navigation interface system, further formatted, if necessary, and passed to either the server or the navigation system as recognizable data for the generation of routing information. Alternatively, the selected information may be acquired by the navigation system. The navigation system may generate routing information locally, acquire routing information from the server, or use both local and remote resources to generate routing information. Once the routing information is generated, the routing information is displayed to the user. FIG. 9d illustrates one example of an illustration of a cellular telephone providing routing information to the user in the form of turn-by-turn instructions. In this example, if the navigation interface system acts as a master, it may send a “route” command to the navigation system following providing the destination information in a format recognizable by the navigation system. This kind of arrangements will make the operation of the navigation system and the navigation interface system seamless to the user.

As described above, certain processes performed by the navigation system may be performed by the navigation interface system, despite the navigation systems ability to process the data. Accordingly, if for example, the unrecognized data is associated with more than one geographic location, as in FIGS. 9a-9d, and the navigation system is required to identify and display only the nearest associated location, either the navigation interface system or the navigation system may process the associated data to determine the nearest location. Either the navigation interface system or the navigation system may process the associated data locally, may access remote resources for processing, or may use both local and remote resources.

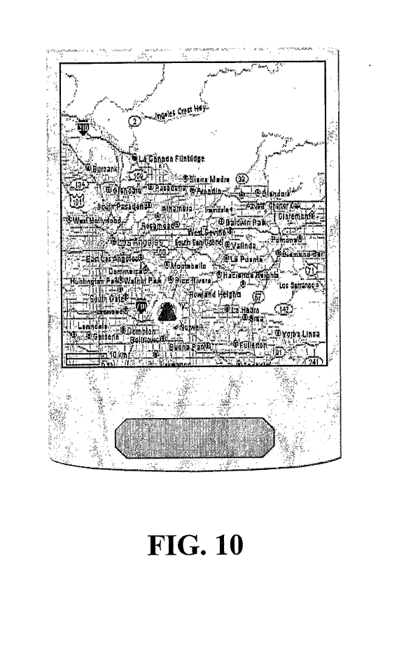

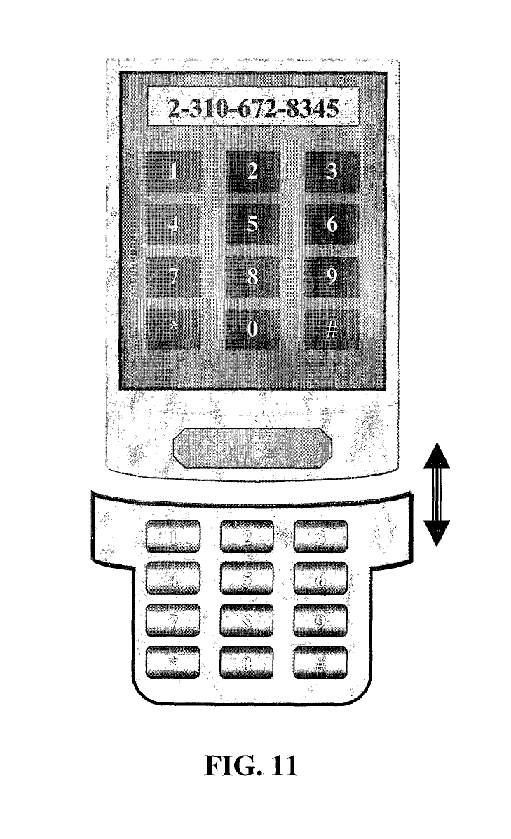

FIGS. 10 & 11 show one example of one implementation of a navigation interface system interfacing with a navigation system, similar to configuration illustrated in FIG. 4. FIG. 10 illustrates one example of a PDA that contains navigation software. FIG. 11 illustrates one example of one implementation of how an external module that includes a numeric keyboard and the navigation interface software may be connected to the PDA illustrated in FIG. 10 via an interface. In this example the navigation interface system is designed to efficiently handle an unrecognizable data, which may take the form of a location code. This module may simply act as an auxiliary input device that can be used as an alternative to the touch screen. On the other hand, this module may include a separate processor, memory, database and networking functions (e.g. wireless network which will allow access to a server) similar to configuration of the example given in FIG. 4. In this example, the navigation interface system may reside on a different platform than the navigation system and/or on multiple program modules.

Persons skilled in the art will understand and appreciate, that one or more processes, sub-processes, or process steps described in connection with FIGS. 2 through 11 may be performed by hardware and/or software. Additionally, the navigation interface system may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

In light of the various implementations offered above, it will be apparent to those of ordinary skill in the art that many more implementations are possible within the scope of this invention than those set forth above. Accordingly, the invention is not to be restricted by the described implementations but is intended to encompass any method of obtaining recognizable data from unrecognizable data and providing it to a navigation system whether implemented in hardware, software or any combination thereof. Further, the invention includes the capability of processing data associated with unrecognizable data and/or providing additional functionality to the navigation system, which may or may not be made available through the navigation system. It is intended that all such additional systems, methods, features and advantages be included within this description, be within the scope of the invention, and be protected by the accompanying claims.

1-32. (canceled)

33. A navigation interface system for communicating with a navigation system, the navigation interface system comprising:
an input device configured to receive unrecognizable data of a defined format, the unrecognizable data having been methodologically assigned to represent a geographic location within a predetermined geographic zone;
a processor configured to obtain associated data associated with the unrecognizable data and provide the associated data to the navigation system in a format that is recognizable by the navigation system.

34. The system of claim 33 where obtaining the associated data includes processing the associated data.

35. The system of claim 33 where the unrecognizable data includes a location code.

36. The system of claim 33 where the associated data includes data that identifies at least one geographic location that is associated with the unrecognized data.

37. The system of claim 33 where the associated data has an association with at least one geographic location.

38. The system of claim 33 where the associated data includes data that identifies at least one event that is associated with the unrecognized data.

39. The system of claim 33 where the associated data is obtained by using a database.

40. The system of claim 33 where the associated data is obtained by using an algorithm.

41. The system of claim 33 where the associated data is obtained from a remote system.

42. The navigation system of claim 33 where the unrecognizable data includes security data and the associated data includes security management information that provides for the authentication of the security data.

43. A signal-bearing medium having software for converting data unrecognizable by a navigation system into data recognizable by the navigation system, the signal-bearing medium comprising:
logic configured to receive unrecognizable data of a defined format, the unrecognizable data having been methodologically assigned to represent a geographic location within a predetermined geographic zone;
logic configured for obtaining associated data associated with the received data; and
logic configured for providing the associated data to the navigation in a format that is recognizable by the navigation system.

44. The signal-bearing medium of claim 43 where the logic configured for obtaining the associated data includes processing the associated data.

45. The signal-bearing medium of claim 43 where the unrecognized data includes a location code.

46. The signal-bearing medium of claim 43 where the associated data includes data that identifies at least one geographic location that is associated with the unrecognized data.

47. The signal-bearing medium of claim 43 where the associated data has an association with at least one geographic location.

48. The signal-bearing medium of claim 43 where the associated data includes data that identifies at least one event that is associated with the unrecognized data.

49. The signal-bearing medium of claim 43 where the logic is further configured to output data.

50. The signal-bearing medium of claim 43 where logic configured for obtaining associated data uses a database.

51. The signal-bearing medium of claim 43 where logic configured for obtaining associated data uses an algorithm.

52. The signal-bearing medium of claim 43 further including logic configured for exchanging data with a remote system.

53. The signal-bearing medium of claim 43 further including logic configured for identifying a location code associated with a geographic location in close proximity to a given location.

54. The signal-bearing medium of claim 43 further including logic configured for receiving a security code and logic to prevent obtaining the associated data unless the security code is authenticated.
